(19) United States
(12) Patent Application Publication
(10) Pub. No.: US 2003/0233784 A1
(43) Pub. Date: Dec. 25, 2003

(54) Insect trap with hologram

(76) Inventors: Michael Feldhege, Koblenz (DE); Michael Roreger, Neuwied (DE); Malgorzata Kloczko, Neustadt/Wied (DE); Iris Schnitzler, Bonn (DE)

Correspondence Address: FROMMER, LAWRENCE & HAUG LLP, 745 Fifth Avenue, New York, NY, 10151, US

(21) Appl. No.: 10/465,213

(22) Filed: Jun. 19, 2003

(30) Foreign Application Priority Data
Jun. 22, 2002 (DE) 10227947.0

(51) Int. Cl. A01M 1/20

(52) U.S. Cl. 43/107

(57) ABSTRACT

An insect trap is described which comprises an insect-attracting element and an insect-holding element, the insect-attracting element being a hologram, that is to say a material in the form of a film which contains the result of a holographic recording method. A cavity or an adhesive, advantageously in the form of an adhesive layer, may be used as the insect-holding element of the insect trap. The insect trap may also contain insecticides and attractants. The use of a hologram is particularly suitable for attraction of flying insect species such as the housefly, the Indian meal moth, the clothes moth, mosquitoes and the common wasp.

The invention relates to an insect trap which contains a hologram.

Traps designed to trap insects have been known for a long time. There are electrically operated traps and those which make do without any external generation of electricity. An attraction effect, which is based on the stimulation of physiological receptors, is used as an essential principle of most traps. To this end, for example, attractants, light effects, signal colors or optical patterns are used. The insects attracted in this way can then be trapped in a cavity, permanently captured by means of adhesive or killed by contact with poison, electric current or heat. Corresponding insect traps are disclosed, for example, in U.S. Pat. No. 5,713,153 (Cook et al.) U.S. Pat. No. 4,686,789 (Williams), WO 97/01271 (Silvandersson), EP 475 665 (Agrisense), EP 446 464 (Bayer), WO 01/78502 (ECS Environment Care Systems) and WO 98/42186 (Silvandersson).

The attraction of insects is based on light effects, color effects and on the release of volatile sexual attractants. The known light effects require an electricity source. The use of pigments which are capable of UV phosphorescence restricts use of the insect traps to the evening twilight period. The use of volatile sexual attractants has the disadvantage that an effect is observed only for a limited time.

It is an object of the invention to provide an insect trap which has a permanent insect-attracting effect that does not rely on electricity. In this context, the aspect of production being as simple as possible is also to be borne in mind.

The object is achieved by an insect trap which comprises an insect-attracting element and an insect-holding element, the insect-attracting element being a hologram.

The term hologram in the scope of the present invention is intended to mean a material in the form of a film which contains the result of a holographic recording method.

A hologram can be produced by using a holographic recording method. A holographic recording method (holography) is a method of forming images of objects three-dimensionally. The information about the object is permanently stored on special material in the form of a film. For recording a hologram, a coherent and sufficiently strong light source is advantageously necessary, as is the case with a laser.

Originally, the “in-line method” of Gabor was used for recording holograms. It was improved after the invention of the laser by working with two beams which do not interfere with one another until immediately in front of the photographic plate. This method is referred to as the “two-beam method”.

The basic principle of the holographic recording method is that, when the object is being illuminated during recording, the laser light is reflected according to the shape of the object. Since reinforcements and cancellations of the light occur during superposition of two waves, the object waves that are reflected by the object become, together with the reference wave of the second beam, an individual pattern of superposed circles on the film. The image of the object is hence not formed directly on the film as in the case of photography. Recorded instead are the wavefronts produced by the object, that is to say the positions of the light waves scattered by the object. The hologram therefore contains substantially more information than a normal photograph, in which only the amplitude distribution is stored, that is to say the intensity of the light, but not the phase distribution.

Observation of the hologram requires a laser with the same wavelength as the one used for recording, except of course for white light reflection holograms which, as the name suggests, can be viewed using normal white light. With the aid of (laser) light, the original object wave is then reproduced by the pattern of the wavefronts on the hologram.

Various types of holograms are suitable for the present invention, especially transmission holograms, Denisjuk holograms, rainbow holograms, image plane holograms, multiplex holograms, embossed holograms or computer-generated holograms.

Transmission Hologram

As the name suggests (Lat.: transmittere=send across), the light has to come through the hologram when such holograms are being viewed, this means: the observer and the light source are situated on different sides of the film. Since the object wave and the reference wave need to strike the film from the same side when recording, the conventional two-beam arrangement is used in this case. The advantage of these holograms is that they have a large depth of field. The depth is in this case limited only by the coherence length of the recording laser. This type of hologram is not so suitable for exhibitions and presentations, since laser light or at least monochromatic light (for example a mercury vapor lamp) is needed for reconstruction.

Denisjuk Hologram

This type of hologram is known after its inventor. The term white light reflection hologram is also used. As the name suggests, these holograms can be reconstructed using normal white light (for example a halogen lamp or direct sunlight). This has the advantage that complicated illumination with laser light is not necessary. Laser light is, however, required for recording. When Denisjuk holograms are being recorded, the reference beam and the object beam strike the film from different sides. A single-beam arrangement is used. During reconstruction, the light must strike the hologram from the same side as the reference beam does during recording. The observer is in this case situated on the same side of the hologram as the light source. Since the modulated light from the light source is reflected to the observer, the term reflection hologram is used

The difference from the transmission hologram is that the object beam and the reference beam strike the film from opposite sides. This leads to so-called “standing waves”, so that an optical grating is formed rather than interference rings. Owing to their opposite directions, the two waves reinforce one another only at very particular points in the film layer. These points do not just lie on a plane, like the interference rings, but rather also extend into the depth of the film, so that the latter needs to have a certain thickness. In the photographic emulsion, there are therefore a plurality of parallel layers with darkened points, and they are about one half of a light wavelength away from one another. The information about the wavelength of the object wave is then stored in the distance from one layer to the next, and the object-specific wavefront is stored in the appearance of the overall grating. Only one wavelength is then reinforced when viewing with white light, namely the one which is determined by the layer spacing. All the other waves cancel out one other. The original object wave is reproduced by diffraction at the grating points. The hologram effectively seeks out, from the white light in which all wavelengths are present, the wavelength with which the original object wavefront can be reconstructed.

Rainbow Hologram

This particular type of hologram is one of the best known and most common. It is distinguished in particular by luminosity and depth of field. Reconstruction is carried out using white light, so that they are white light holograms. The crucial disadvantage, however, is that vertical parallax is entirely absent. This means that it is possible to look around at the object from the left and right, but if the vertical viewing angle is changed then the object cannot be observed from above and below. The reason for this is due to the method of recording rainbow holograms. They are produced using a two-stage method. A transmission hologram is made first. A plurality of rainbow holograms can then be produced from this so-called master hologram. In the second step, a hologram is recorded of an object which is in fact no longer present. This is done in the following way: a slit of the master hologram is illuminated with laser light, and the object is thereby reconstructed in space. The film plate is placed in this virtual image and illuminated with a reference beam. Since only a slit of the master hologram is used, vertical parallax is absent. During reconstruction, only a spectral decomposition of the light takes place in the vertical direction, which means that the object appears from top to bottom in different spectral colors (rainbow colors), to which the name is attributed. Rainbow holograms are transmission holograms. In order to allow simpler reconstruction, a reflective layer is fitted behind the layer of the material in the form of the film. The hologram does not therefore need to be illuminated from behind.

Image Plane Hologram

Image plane holograms are a further type of hologram. They can be reconstructed using white light and are a subset of reflection holograms. The special feature of them is that the object appears to hover in the film plane. This means that one half of the object is to be seen in front of the film, and the other behind the film. A trick is used when recording such holograms: a master hologram is made first as an entirely normal transmission hologram. The recording of the image plane hologram is then carried out similarly to the case of rainbow holograms, but this time the film is placed not in the virtual image but in the real image. It should also be mentioned that no slit is needed for reconstruction in this case, and there is both vertical and horizontal parallax in the finished hologram.

Multiplex Hologram

Multiplex holograms are a particularly interesting type of hologram. These holograms have the special feature that they not only represent a three-dimensional image but also have the possibility of capturing movements, and therefore of in fact recording the fourth dimension, namely time. To this end, a normal film is firstly shot, for example of a person, while the camera moves around the person. A narrow (about 2 mm) strip hologram of each image of this film, which of course captures the movement process only two-dimensionally, is subsequently recorded on the hologram plate. The rest of the film is covered for this. The result is a hologram which consists of more than 1000 different strip holograms. The information of these individual holograms is likewise two-dimensional. The third dimension is in this case obtained only by stereoscopic viewing. For example, the left eye can see an image which is stored further to the left in the hologram than the image which is seen by the right eye. Since the camera has moved around the object during recording, each image has a different angle of viewing the object. The brain hence constructs a three-dimensional structure from the two images. If the observer now moves around the hologram, then he or she sees one strip hologram after another. Since the images differ from one another chronologically, the movement can be clearly observed.

Embossed Hologram

Owing to their high and complicated production outlay, these holograms are highly forgery-proof. They are used, for example, on credit cards. If the angle of viewing the hologram changes, then a movement can be observed where applicable. This type of hologram is distinguished, in particular, by the fact that the holograms can be copied in any size of production run with relatively little outlay. They are seen on a silver background. A normal white light reflection hologram needs to be produced first.

Computer-Generated Hologram

Embossed holograms whose interference patterns are calculated using computers are also produced. The need to produce a white light hologram is obviated in this case. However, a special film is used in which the interference pattern effectively leaves the diffraction grating behind as a relief. An impression of this relief is made and an embossing stamp is produced. The stamp is used to emboss any desired number of holograms in a very thin film. The film is finally evaporation coated from behind with a silver layer.

The term “in the form of a film” is intended to mean that the material which contains the result of the holographic recording method extends essentially in only two dimensions. In the insect trap, the “material in the form of a film” therefore represents a thin layer.

The polymer materials known to the person skilled in the art, especially those for photographic films, are suitable as a material which contains the result of the holographic recording method. Examples of such polymer materials include gelatin, polyvinyl chloride, polyacrylonitrile, polyacrylates, polyesters, polyethylene terephthalate, polypropylene, polyethylene, ethylene-vinyl acetate copolymers, polyvinyl pyrrolidone (PVP), polyvinyl alcohol (PVA).

The insect trap may also contain a reflective layer, which acts as a mirror for the hologram. It is therefore advantageously arranged directly under the layer that contains the hologram. The effect of the reflective layer is that after having passed through the hologram, the incident light is reflected through the latter. An example of a suitable material for the reflective layer is aluminum. This can be coated as a foil onto the material in the form of a film, or evaporated on directly.

The insect-holding element of the insect trap is intended to mean the part of the trap which causes the attracted insect to become trapped. In the simplest case, it is a cavity (for example a box, bag, net-like structure etc.) which has at least one opening for the insects to enter, but whose design makes it difficult or permanently impossible for the insect to escape from it, and therefore leads to the death of the insect in the long term.

However, the insect-holding element may also be an adhesive which, in a particular embodiment, is present as a layer. The adhesive may be made of at least one contact-bonding polymer. It may also be made of a non-bonding polymer, in which case a tackifier needs to be contained in it. Such tackifiers may also be added to an adhesive made of at least one contact-bonding polymer, in order to enhance the bonding power. Contact-bonding polymers are known to the person skilled in the art, examples including polyisobutylenes, polyacrylates or silicones.

Tackifiers are likewise known to the person skilled in the art, examples including resins and esters of (hydrogenated) abietic acid.

In a preferred embodiment, the adhesive layer is arranged above the layer containing the hologram. The adhesive layer is advantageously covered with a protective film, which is not removed until immediately before the insect trap is used, in order to avoid undesired adhesion of the insect trap.

The insect trap may also contain insecticides and other substances and devices known to the person skilled in the art for killing insects.

Besides the hologram, the insect trap may also contain further elements known to the person skilled in the art for attracting insects, for example attractants, feeding stimulants, colored pigments, phosphorescent pigments, light effects, geometrical patterns etc.

In particular embodiments of the insect trap, these substances (insecticides, attractants, feeding stimulants, colored pigments, phosphorescent pigments), if they are contained in the insect trap, are contained in a separate layer and/or in the adhesive layer.

Insects are a class of the phylum Arthropoda (jointed appendages). This phylum differs from all other animals by having a segmented, shell-like external or exoskeleton. Examples include springtails, proturans, diplurans, bristletails, silverfish, mayflies, dragonflies, stoneflies, webspinners, ensiferans, caeliferans, earwigs, notopterans, mantids, cockroaches, stick-insects, termites, zorapterans, booklice, lice, thrips, true bugs, cicadas, sternorrhynchans, megalopterans, camelneck flies, lacewings, scorpion flies, caddis flies, lepidopterans, true flies, fleas, hymenopterans, beetles and stylopids. Especially relevant are the flying insect species found indoors, for example Musca domestica (housefly), Plodia interpunctella (Indian meal moth), Tineola bisselliella (clothes moth), Anopheles, Aedes or Culex species (mosquitoes) or Vespula vulgaris (common wasp).

The insect trap can be produced by straightforward methods, for example by adhesively bonding a commercially available hologram onto one side in the interior of the relevant cavity. When an adhesive is being used as the insect-holding element, it may be applied (preferably directly) to the hologram, for example by known methods such as extrusion, lamination, coating etc.

The invention will be illustrated by the following figures, but without limiting it to them.

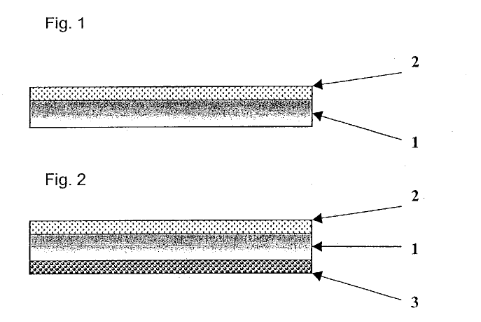

FIG. 1 shows the cross section of an embodiment of the insect trap according to the invention, which has a hologram as the insect-attracting element and an adhesive layer as the insect-holding element.

FIG. 2 shows the cross section of the embodiment as in FIG. 1, but which additionally has a reflective layer.

In the figures, the references have the following meaning:

1=hologram (material in the form of a film, which contains the result of a holographic recording method)

2=adhesive layer

3=reflective layer

1. An insect trap comprising an insect-attracting element and an insect-holding element, characterized in that the insect-attracting element is a hologram.

2. The insect trap as claimed in claim 1, characterized in that the hologram is a transmission hologram, a Denisjuk hologram (white light reflection hologram), a rainbow hologram, an image plane hologram, a multiplex hologram, an embossed hologram or a computer-generated hologram.

3. The insect trap as claimed in claim 1 or 2, characterized in that the insect-holding element is a cavity and/or adhesive.

4. The insect trap as claimed in one or more of claims 1 to 3, characterized in that a reflective layer is arranged under the hologram.

5. The insect trap as claimed in one or more of claims 1 to 4, characterized in that it additionally contains at least one insecticide, attractant, feeding stimulant, colored pigment, phosphorescent pigment or geometrical pattern.

6. The insect trap as claimed in one or more of claims 1 to 5, characterized in that the adhesive is contained in the form of a layer.

7. The use of a hologram to attract insects.

8. A method for attracting and trapping insects, characterized in that an insect is attracted by means of a hologram as the insect-attracting element and is permanently captured by means of an insect-holding element.
